(19) United States
(12) Patent Application Publication
(10) Pub. No.: US 2002/0066579 A1
(43) Pub. Date: Jun. 6, 2002

(54) Universal drive and earth auger attachment for commercial work vehicle

(76) Inventor: Edward Jasper, Mendota, IL (US)

Correspondence Address: LEYDIG VOIT & MAYER, LTD, 6815 WEAVER ROAD, ROCKFORD, IL, 61114-8018, US

(21) Appl. No.: 09/728,114

(22) Filed: Dec. 1, 2000

(51) Int. Cl. A01B 23/06; E21B 10/44

(52) U.S. Cl. 172/532; 175/394

(57) ABSTRACT

A universal drive and earth auger attachment for commercial work vehicles such as skid steer loaders. The reduction drive reduces the speed between the rotary actuator and the earth auger. The reduction drive includes an input connected to a rotary actuator and an output shaft adapted to be inserted into different types of sockets of earth augers. Earth augers commonly have either a cylindrical socket or a hexagonal socket. The reduction drive can be connected to either type of socket and therefore is universal among the different types of commercially available augers.

### FIELD OF THE INVENTION

The present invention relates generally to mechanical connections and more particularly to shaft socket connections, especially between earth augers and rotary actuators of earth auger attachments for commercial work vehicles.

### BACKGROUND OF THE INVENTION

Earth auger attachments are one of the many different useful attachments for commercial work vehicles such as skid steer loaders and other similar such vehicles. An earth auger attachment is used to quickly dig relatively deep cylindrical holes in the ground for any of a variety of purposes such as mounting wooden poles. The earth auger attachment is powered by the commercial work vehicle and typically includes a reduction drive to reduce speed and increase the torque applied to the earth auger.

One of the difficulties for machinery manufacturers is that there are two common and different types of augers used for these attachments, ones with hexagonal sockets and ones with cylindrical sockets. The socket receives the output shaft end of the reduction drive and is connected thereto by a shear pin that sheers at a predetermined load or other axial retention mechanism. With the two common forms of augers, machinery manufacturers have had the burden of stocking two different types of commercially available reduction drives, ones with hexagonal connection shafts and ones with cylindrical connection shafts. This burden is especially great as customer demand is often cyclical and somewhat hard to predict. A further difficulty occurs to the end user in the event that wear on the auger necessitates replacement. Such replacement requires the user to find the right supplier with the right form of earth auger for mounting.

### SUMMARY OF THE INVENTION

In view of the foregoing, it is the primary objective of the present invention to solve the difficulties associated in the art of earth auger attachments, namely the prior requirement of double stocking of reduction drives to accommodate different forms of earth augers and the difficulty end users may have in locating a replacement earth auger.

In view of these and other objectives, the present invention is directed toward an earth auger attachment and a universal reduction drive which may be used in the earth auger attachment. The earth auger attachment includes an auger having a central shaft and a helical vane surrounding the shaft for engaging earth material. The shaft has a socket at one end for receiving a output shaft. The attachment also includes a rotary actuator that is powered by the commercial work vehicle typically via its hydraulic system. The rotary actuator is usually connected through a reduction drive (typically either a gear reduction drive or a chain and sprocket reduction drive) to the earth auger but may also be directly coupled thereto. The reduction drive has an input connected to the rotary actuator and an output shaft inserted into the socket of the earth auger. The reduction drive reduces rotary speed from the input to the output shaft and thereby increases torque. The output shaft has (a) a first section of a first configuration adapted to be received in a first type of socket (b) a second section of a second configuration different from the first configuration adapted to be received in a second type of socket, thereby providing a universal reduction drive. Each section includes a different through-hole that receives a shear pin or other connection pin for the purpose of attaching the earth auger to the reduction drive. According to the preferred embodiment, the first section is cylindrical and the second section is hexagonal.

Other objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a perspective illustration of an earth auger mounted on a skid steer loader in accordance with a preferred embodiment of the invention.

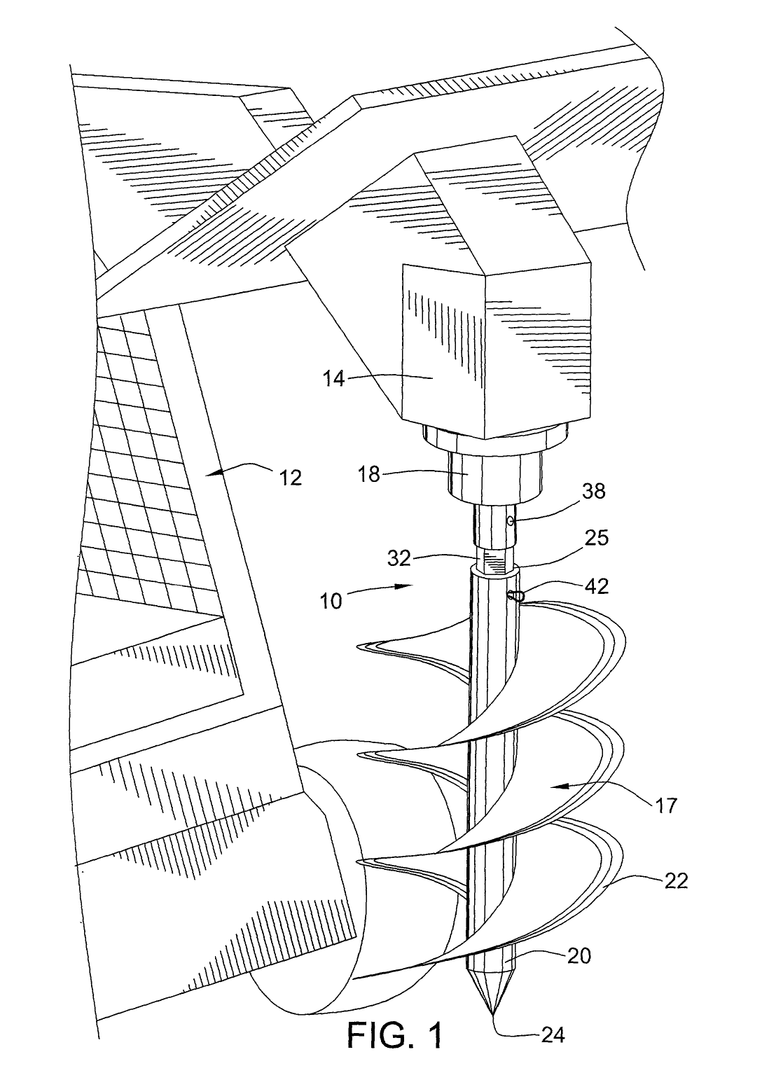

FIG. 2 is a perspective illustration of the gear reducer used on the earth auger shown in FIG. 1.

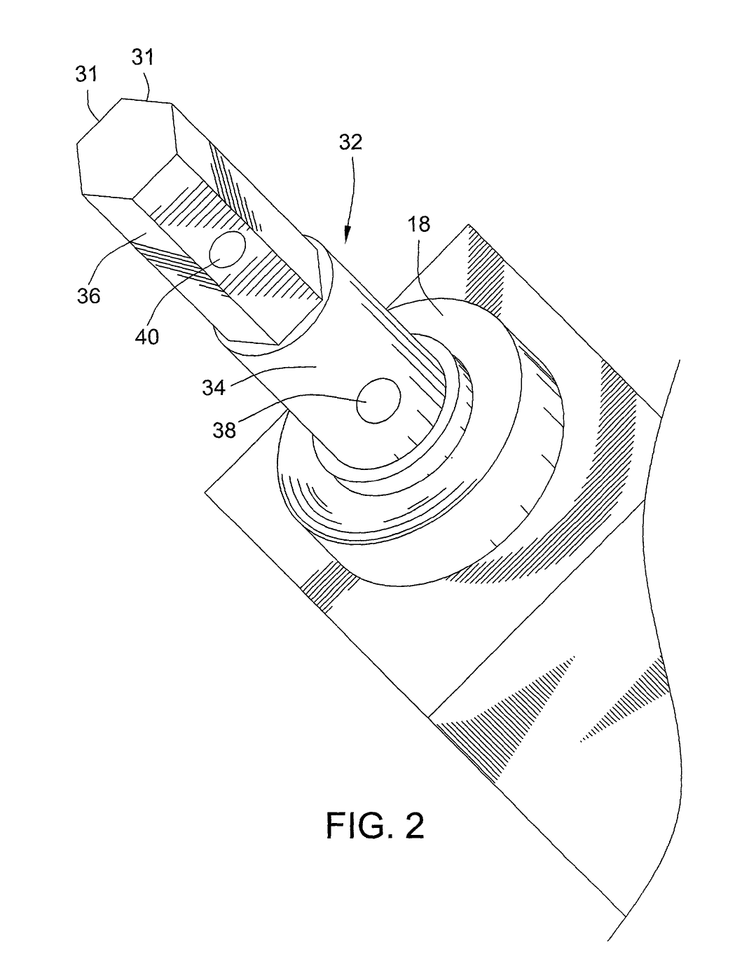

FIGS. 3a and 3b are perspective illustrations of portions of earth augers, namely, the output shaft of the gear reducer and socket of both augers.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE PREFERRED EMBODIMENTS

For purposes of illustration, a preferred embodiment of the present invention is shown incorporated in an earth auger attachment 10 for selective attachment to and detachment from a commercial vehicle depicted as a skid steer loader 12. The earth auger attachment 10 includes an actuator in the form of hydraulic motor 14, an earth auger 17 and a reduction drive 18 (either a gear reduction drive or chain and sprocket reduction drive) connecting the hydraulic motor 14 and earth auger 17 for the purpose of reducing rotational speed and increasing torque. Alternatively the output of the hydraulic motor 14 may be directly connected to the earth auger 17 without a reduction drive.

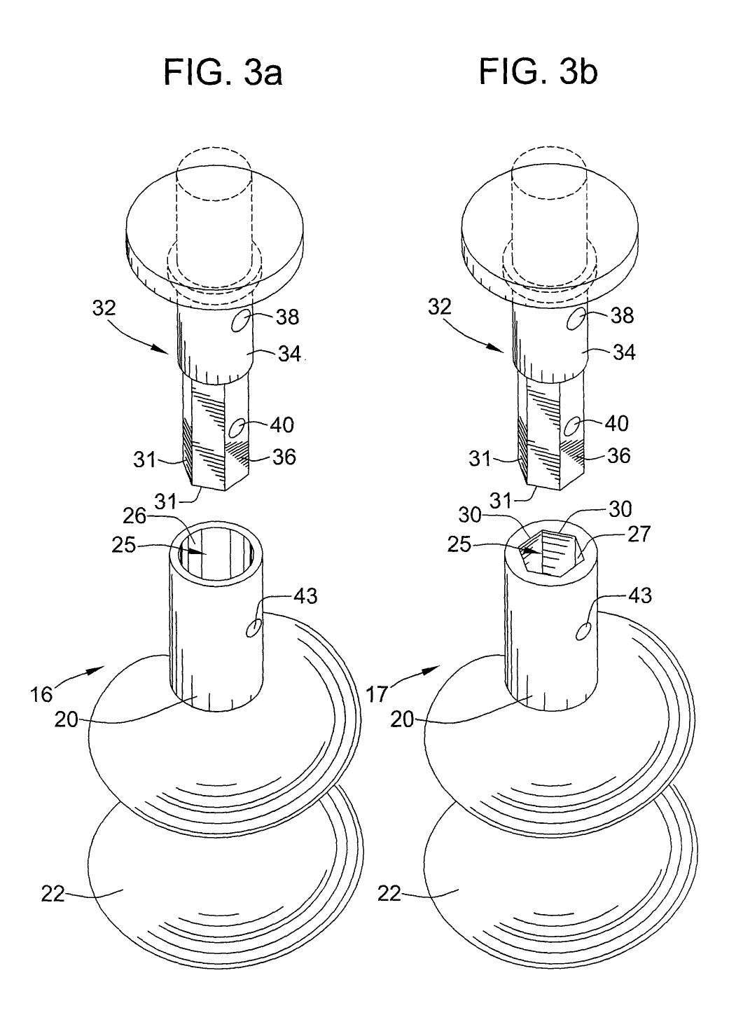

The earth auger 17 includes a central shaft 20 and a helical vane 22 adapted to engage the ground surface for the purpose of digging relatively deep holes. The earth auger 17 includes an engaging end 24 at one end and a socket 25 at the other end that connects to the reduction drive 18. As is common in commercially available earth augers, the socket 25 may have either a cylindrical configuration 26 as shown in the earth auger 16 of FIG. 3a or a hexagonal configuration 27 with six equally sized flats 30 as shown in the earth auger 17 FIG. 3b.

To accommodate the different forms of earth augers 16, 17, the reduction drive 18 includes a universal output shaft 32 capable of fitting both hexagonal and cylindrical socket configurations 26, 27. The universal output shaft 32 includes a cylindrical section 34 and a hexagonal section 36, each having a separate through hole 38, 40 that receive a pin 42 or other axial retention mechanism for the purpose of coupling the respective earth augers 16, 17 to the gear reduction drive 18 via hole 43 in the earth auger. The cylindrical section 34 has a diameter that closely corresponds to the diameter of the cylindrical socket configuration 26. Likewise, the hexagonal section 36 has a width between flats 31 and corners that closely corresponds to those of hexagonal socket configuration 27. The close dimensional sizing ensures the proper support of the earth auger.

In the preferred embodiment, the hexagonal section 36 projects axially from the cylindrical section 34 to form the terminating end of the output shaft 32. The smaller sized section is placed at the terminating or free end to ensure tight fits between the augers 16, 17 and their respective mounting sections 34, 36 of the output shaft.

The foregoing description of various preferred embodiments of the invention has been presented for purposes of illustration and description. It is not intended to be exhaustive or to limit the invention to the precise forms disclosed. Obvious modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An earth auger attachment for attachment and detachment to and from a commercial work vehicle, comprising:
an earth auger having a central shaft and a helical vane surrounding the shaft for engaging earth material, the shaft having socket at one end;
a rotary actuator adapted to be powered by the commercial work vehicle;
a reduction drive interposed between the earth auger and the rotary actuator, having an input connected to the rotary actuator and an output shaft inserted into the socket, wherein the reduction drive reduces rotary speed from the input to the output shaft; and
wherein the output shaft has:
(a) a first section of a first configuration adapted to be received in a first type of socket, the first section including a first through hole for receiving a connection pin;
(b) a second section of a second configuration different from the first configuration adapted to be received in a second type of socket, the second section including a second through hole for receiving a connection pin.

2. The earth auger attachment of claim 1 wherein the first section has a cylindrical configuration and wherein the second section is hexagonal.

3. The earth auger attachment of claim 2 wherein the second section projects from the first section to a terminating free end, and wherein the diameter of the cylindrical first section is greater than the width between corners of the hexagonal second section.

4. The earth auger attachment of claim 3 wherein the output shaft is universally adapted to connect to a first earth auger having a hexagonal socket and a second earth auger having a cylindrical socket.

5. A reduction drive comprising an input adapted to connect to a rotary actuator and an output shaft adapted to be inserted into a socket, wherein the reduction drive reduces rotary speed from the input to the output shaft; and wherein the output shaft has: (a) a first section of a first configuration adapted to be received in a first type of socket, the first section including a first through hole for receiving a connection pin; and (b) a second section of a second configuration different from the first configuration adapted to be received in a second type of socket, the second section including a second through hole for receiving a connection pin.

6. The reduction drive of claim 5 wherein the first section has a cylindrical configuration and wherein the second section is hexagonal.

7. The reduction drive of claim 6 wherein the second section projects from the first section to a terminating free end, and wherein the diameter of the cylindrical first section is greater than the width between corners of the hexagonal second section.

8. An earth auger attachment for attachment and detachment to and from a commercial work vehicle, comprising:
an earth auger having a central shaft and a helical vane surrounding the shaft for engaging earth material, the shaft having socket at one end;
a rotary actuator adapted to be powered by the commercial work vehicle;
output shaft interposed between the rotary actuator and the earth auger including an axial retention mechanism adapted to retain the earth auger to the output shaft, the output shaft having:
(a) a first section of a first configuration adapted to be received in a first type of socket;
(b) a second section of a second configuration different from the first configuration adapted to be received in a second type of socket.

9. The earth auger attachment of claim 8 further comprising a reduction drive interposed between the earth auger and the rotary actuator, having an input connected to the rotary actuator and providing the output shaft inserted into the socket, wherein the reduction drive reduces rotary speed from the input to the output shaft.

10. The earth auger attachment of claim 8 wherein the first section has a cylindrical configuration and wherein the second section is hexagonal.

11. The earth auger attachment of claim 10 wherein the second section projects from the first section to a terminating free end, and wherein the diameter of the cylindrical first section is greater than the width between corners of the hexagonal second section.

12. The earth auger attachment of claim 11 wherein the output shaft is universal adapted to connect to a first earth auger having a hexagonal socket and a second earth auger having a cylindrical socket.
